(19) United States
(12) Patent Application Publication
(10) Pub. No.: US 2014/0075302 A1
(43) Pub. Date: Mar. 13, 2014

(54) ELECTRONIC APPARATUS AND HANDWRITTEN DOCUMENT PROCESSING METHOD

(71) Applicant: KABUSHIKI KAISHA TOSHIBA, Tokyo (JP)

(72) Inventor: Aiko AKASHI, Ome-shi (JP)

(73) Assignee: Kabushiki Kaisha Toshiba, Tokyo (JP)

(21) Appl. No.: 13/680,550

(22) Filed: Nov. 19, 2012

(30) Foreign Application Priority Data
Sep. 7, 2012 (JP) 2012-197308

(51) Int. Cl. G06F 17/24

(52) U.S. Cl. CPC G06F 17/24
USPC 715/268

(57) ABSTRACT

According to one embodiment, an electronic apparatus includes a layer creator and a storage processor. The layer creator creates, when a handwritten document including a first layer is displayed, a second layer. The storage processor stores first layer information and first stroke data if a first stroke is handwritten in a first region of the first layer, and stores second layer information and second stroke data if a second stroke is handwritten in a second region of the second layer, the first layer information indicative of the first region, the first stroke data corresponding to the first stroke, the second layer information indicative of the second region, and the second stroke data corresponding to the second stroke.

### CROSS-REFERENCE TO RELATED APPLICATIONS

This application is based upon and claims the benefit of priority from Japanese Patent Application No. 2012-197308, filed Sep. 7, 2012, the entire contents of which are incorporated herein by reference.

### FIELD

Embodiments described herein relate generally to an electronic apparatus capable of processing handwritten documents and a handwritten document processing method used by the electronic apparatus.

### BACKGROUND

In recent years, various electronic devices such as a tablet, a PDA, and a smartphone have been developed. Most of such kinds of electronic devices include a touch-screen display to facilitate an input operation by the user.

The user can give instructions to the electronic device to execute a function related to a menu or object by touching the menu or object displayed on the touch-screen display by a finger or the like.

However, most of existing electronic devices with a touch-screen display are consumer products pursuing operability for various kinds of media data like images, music and others and are not necessarily suitable for use in business scenes like conferences, business negotiations, and product development. Thus, paper notebooks are still widely used in business scenes.

Also, such a paper notebook is generally used by attaching a sticky note (slip) to describe additional information to a paper page. By using such a sticky note, the user can add a comment or the like on a paper page without changing description itself on the page.

Like the paper notebook, there are cases that it is expected to add handwriting data such as a sticky note to handwritten document data that is processed by electronic devices. For example, a function is expected for writing information relating to a handwriting page not on the page itself or another page but on an additional layer such as a sticky note.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an external appearance of an electronic apparatus according to an embodiment.

FIG. 2 is a view showing an example of a handwritten document handwritten on a touch-screen display of the electronic apparatus of the embodiment.

FIG. 3 is an exemplary view for explaining time-series information corresponding to the handwritten document in FIG. 2, the time-series information being stored in a storage medium by the electronic apparatus of the embodiment.

FIG. 4 is an exemplary block diagram showing a system configuration of the electronic apparatus of the embodiment.

FIG. 5 is an exemplary block diagram showing a functional configuration of a digital notebook application program executed by the electronic apparatus of the embodiment.

FIG. 6 is a view showing an example in which a layer is created in a handwritten document displayed by the electronic apparatus of the embodiment.

FIG. 7 is a view showing an example of a handwritten document including a plurality of layers displayed by the electronic apparatus of the embodiment.

FIG. 8 is an exemplary view for explaining overlapped layers in FIG. 7.

FIG. 9 is a view showing a configuration example of layer information used by the electronic apparatus of the embodiment.

FIG. 10 is a diagram showing an example in which a layer region set to the handwritten document in FIG. 6 is changed.

FIG. 11 is a diagram showing another example of the handwritten document including a plurality of layers displayed by the electronic apparatus of the embodiment.

FIG. 12 is a diagram showing an example in which layers are displayed in different colors (brightness) in the handwritten document in FIG. 11.

FIG. 13 is a diagram showing another example in which layers are displayed in different colors (brightness) in the handwritten document in FIG. 11.

FIG. 14 is an exemplary flowchart showing the procedure of input operation process performed by the electronic apparatus of the embodiment.

FIG. 15 is an exemplary view showing an operation of an external device and the electronic apparatus of the embodiment.

### DETAILED DESCRIPTION

Various embodiments will be described hereinafter with reference to the accompanying drawings.

In general, according to one embodiment, an electronic apparatus includes a layer creator, a storage processor and a display processor. The layer creator is configured to create, when a handwritten document including a first layer is displayed on a screen, a second layer. The storage processor is configured to store first layer information and first stroke data in storage if a first stroke is handwritten in a first region corresponding to the first layer, and to store second layer information and second stroke data in the storage if a second stroke is handwritten in a second region corresponding to the second layer, the first layer information indicative of the first region, the first stroke data corresponding to the first stroke, the second layer information indicative of the second region, and the second stroke data corresponding to the second stroke. The display processor is configured to display the first stroke in the first region and to display the second stroke in the second region.

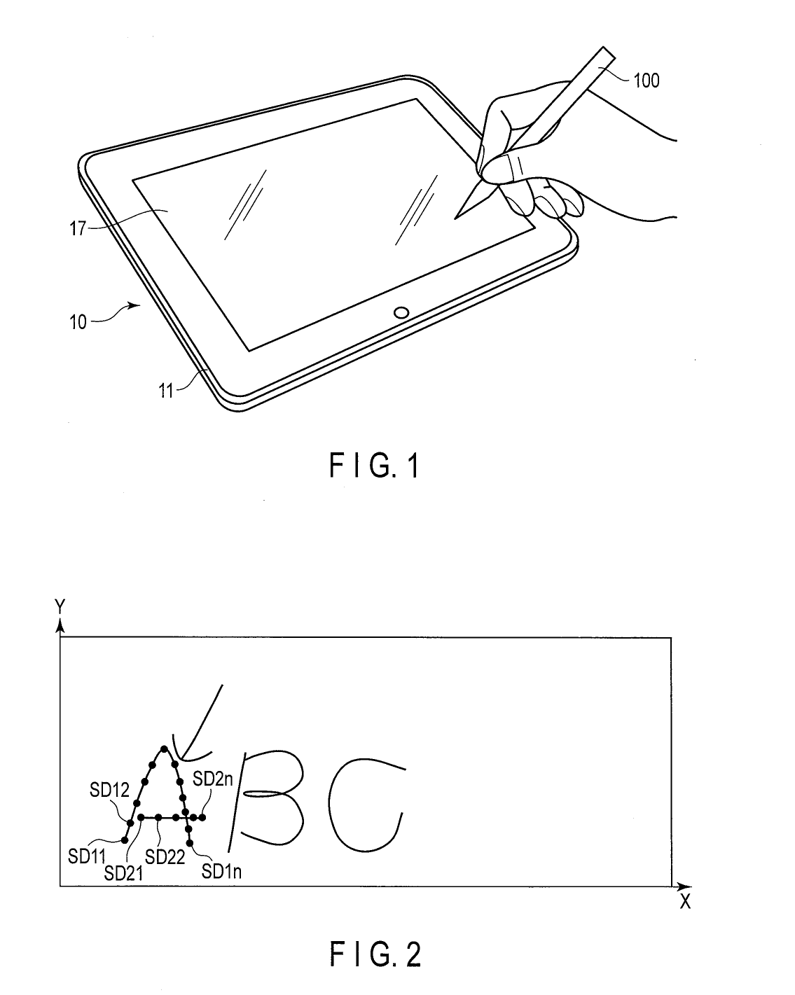

FIG. 1 is a perspective view showing an external appearance of an electronic apparatus according to an embodiment. The electronic apparatus is, for example, a pen-based portable electronic apparatus which can execute a handwriting input by a pen or a finger. The electronic apparatus may be realized as a tablet computer, a notebook-type personal computer, a smartphone, a PDA, etc. In the description below, it is assumed that the electronic apparatus is realized as a tablet computer 10. The tablet computer 10 is a portable electronic device which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. A flat-panel display and a sensor are built into the touch-screen display 17. The sensor is configured to detect a touch position of a pen or a finger on the screen of the flat-panel display. The flat-panel display may be, for instance, a liquid crystal display (LCD). As the sensor, for example, use may be made of a capacitance-type touch panel, or an electromagnetic induction-type digitizer. In the description below, it is assumed that two kinds of sensors, namely a digitizer and a touch panel, are both built in the touch-screen display 17.

Each of the digitizer and the touch panel is provided in a manner to cover the screen of the flat-panel display. The touch-screen display 17 detects not only a touch operation on the screen with use of a finger, but also a touch operation on the screen with use of a pen 100. The pen 100 may be, for instance, an electromagnetic-induction pen.

The user can perform a handwriting input operation on the touch-screen display 17 by using an external object (pen 100 or finger). During the handwriting input operation, a path (trajectory) of movement of the external object (pen 100 or finger) on the screen, that is, a path (a trace of writing) of a stroke that is handwritten by the handwriting input operation, is drawn in real time, and thereby the path of each stroke is displayed on the screen. A path of movement of the external object during a time in which the external object is in contact with the screen corresponds to one stroke. A set of many strokes corresponding to handwritten characters or graphics, that is, a set of many paths (traces of writing), constitutes a handwritten document.

The handwritten document includes one or more layers. A layer is a region where one or more strokes input by handwriting can be displayed and can be overlapped with other layers. More specifically, a handwritten document includes a base document layer to be a base of the handwritten document. The handwritten document further includes a new layer which is created in response to a layer creation operation by the user and is laid on the base document layer. The new layer is created, for example, in any region specified by a path of movement of an external object on the touch-screen display 17 during a layer creation operation. Therefore, paths of strokes are drawn in one of one or more layers in the handwritten document by the above handwritten input operation and the paths of strokes are thereby displayed on the screen.

The user can perform not only a layer creation operation to instruct the creation of any layer in the displayed handwritten document, but also a layer change operation to instruct the change of the position, size, or overlapping order of any layer in the displayed handwritten document, the deletion of any layer in the displayed handwritten document or the like. The user also performs the layer change operation to instruct the displaying/hiding of strokes drawn in each layer.

Whether a handwritten input operation or a layer creation (change) operation is performed on the touch-screen display 17 is determined, for example, based on the set mode. For example, an operation on the touch-screen display 17 in handwriting mode is detected as a handwritten input operation and an operation on the touch-screen display 17 in operation mode is detected as a layer creation operation. These modes are switched by, for example, an operation of a button provided in the pen 100, an operation of a mode switching button displayed on the screen of the touch-screen display 17, a predetermined operation (for example, a touch operation that is not slide for a predetermined time or longer) on the touch-screen display 17 or the like.

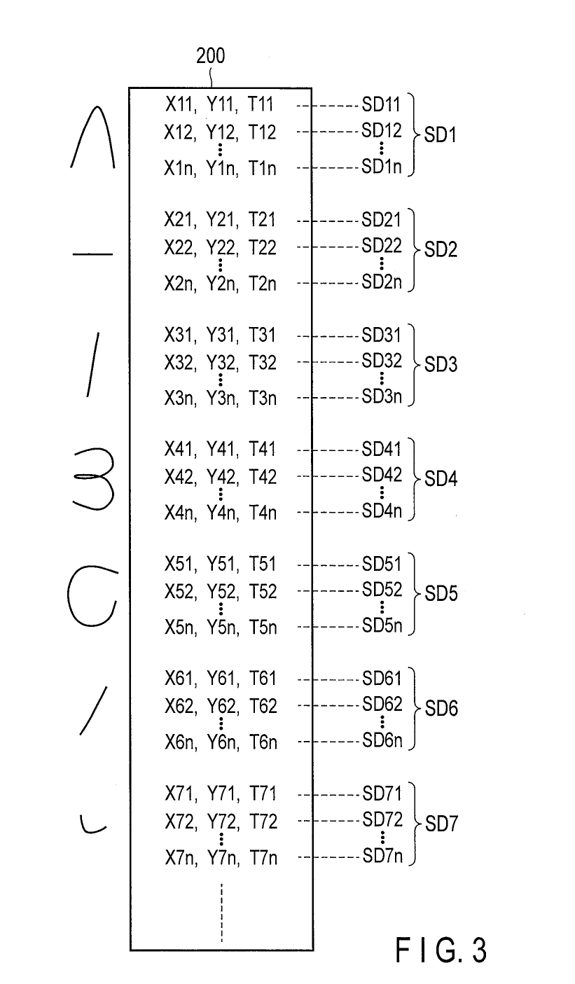

In the present embodiment, the handwritten document is stored in a storage medium not as image data but as handwritten document data which includes layer information indicative of each of one or more layers and time-series information indicative of time-series coordinates of a path of each stroke drawn in each layer and the handwriting order of the strokes. Details of the time-series information will be described later with reference to FIG. 3. The time-series information generally means a set of time-series stroke data items respectively corresponding to a plurality of strokes. Each stroke data item corresponds to a stroke and includes a coordinate data series (time series coordinates) respectively corresponding to points on the path of the stroke. The order of the stroke data items corresponds to the order in which each stroke is handwritten. The layer information includes information indicative of a region in the handwritten document where each layer is arranged and information indicative of the order in which one or more layers are laid on.

The tablet computer 10 can read any existing handwritten document data from a storage medium to display the handwritten document corresponding to the handwritten document data, that is, the handwritten document in which the path of each of strokes indicated by time-series information is drawn in each of one or more laid layers indicated by layer information on the screen.

Next, the relationship between a stroke (e.g. a character, mark, figure, or table) handwritten by a user and time-series information will be described with reference to FIGS. 2 and 3. FIG. 2 shows an example of the handwritten document (handwritten character string) handwritten on the touch-screen display 17 by using the pen 100 or the like.

In a handwritten document, there are frequently cases in which a character, figure or the like is handwritten and another character, figure or the like is further handwritten on the character, figure or the like. In FIG. 2, a case in which a handwritten character string “ABC” is handwritten in the order of “A”, “B”, and “C” and then a handwritten arrow is handwritten close to the handwritten character “A” is assumed.

The handwritten character “A” is represented by two strokes (a path in a “Λ” shape and a path in a “−” shape) handwritten using the pen 100 or the like, that is, two paths. The path of the pen 100 in the “Λ” shape firstly handwritten is sampled, for example, in real time at equal intervals, thereby obtaining time series coordinates SD11, SD12, . . . , SD1n of a stroke in the “Λ” shape. Similarly, the path of the pen 100 in the “−” shape secondly handwritten is sampled, thereby obtaining time series coordinates SD21, SD22, . . . , SD2n of a stroke in the “−” shape.

The handwritten character “B” is represented by two strokes handwritten using the pen 100 or the like, that is, two paths. The handwritten character “C” is represented by one stroke handwritten using the pen 100 or the like, that is, one path. The handwritten “arrow” is represented by two strokes handwritten using the pen 100 or the like, that is, two paths.

FIG. 3 shows time-series information 200 corresponding to the handwritten document in FIG. 2. The time-series information includes a plurality of stroke data items SD1, SD2, . . . , SD7. In the time-series information 200, the stroke data SD1, SD2, . . . , SD7 is arranged in time series in the order of handwriting, that is, the order in which a plurality of strokes is handwritten.

In the time-series information 200, the first and second stroke data items SD1, SD2 indicate two strokes of the handwritten character “A”. The third and fourth stroke data items SD3, SD4 indicate two strokes of the handwritten character “B”. The fifth stroke data item SD5 indicates one stroke of the handwritten character “C”. The sixth and seventh stroke data items SD6, SD7 indicate two strokes of the handwritten “arrow”.

Each stroke data item includes a coordinate data series (time-series coordinates) corresponding to one stroke, that is, a plurality of coordinates corresponding to a plurality of points on a path of the one stroke. In each stroke data item, the coordinates are arranged in time series in the order in which the stroke is written. Regarding the handwritten character “A”, for example, the stroke data SD1 includes a coordinate data series (time-series coordinates) corresponding to points on the path of the stroke in the “A” shape of the handwritten character “A”, that is, n coordinate data items SD11, SD12, . . . , SD1n. The stroke data SD2 includes a coordinate data series corresponding to points on the path of the stroke in the “-” shape of the handwritten character “A”, that is, n coordinate data items SD21, SD22, . . . , SD2n. Incidentally, the number of coordinate data items may be different from stroke data to stroke data.

Each coordinate data item indicates an X coordinate and a Y coordinate corresponding to one point in the corresponding path. For example, coordinate data SD11 indicates an X coordinate (X11) and a Y coordinate (Y11) of the start point of the stroke in the “Λ” shape. SD1n indicates an X coordinate (X1n) and a Y coordinate (Y1n) of the end point of the stroke in the “Λ” shape.

Further, each coordinate data item may include time stamp information T corresponding to a timing when the point corresponding to the coordinates is handwritten. The timing of handwriting may be an absolute time (for example, year, month, day, hour, minute, second) or a relative time relative to some timing as a reference. For example, the absolute time (for example, year, month, day, hour, minute, second) when a stroke is started to be written may be added to each stroke data item as time stamp information and further, a relative time indicating a difference from the absolute time may be added to each coordinate data item in the stroke data as time stamp information T.

Thus, by using time-series information in which the time stamp information T is added to each coordinate data item, the temporal relationship between strokes can be represented more precisely.

Further, information (Z) indicative of a handwriting pressure may be added to each coordinate data item.

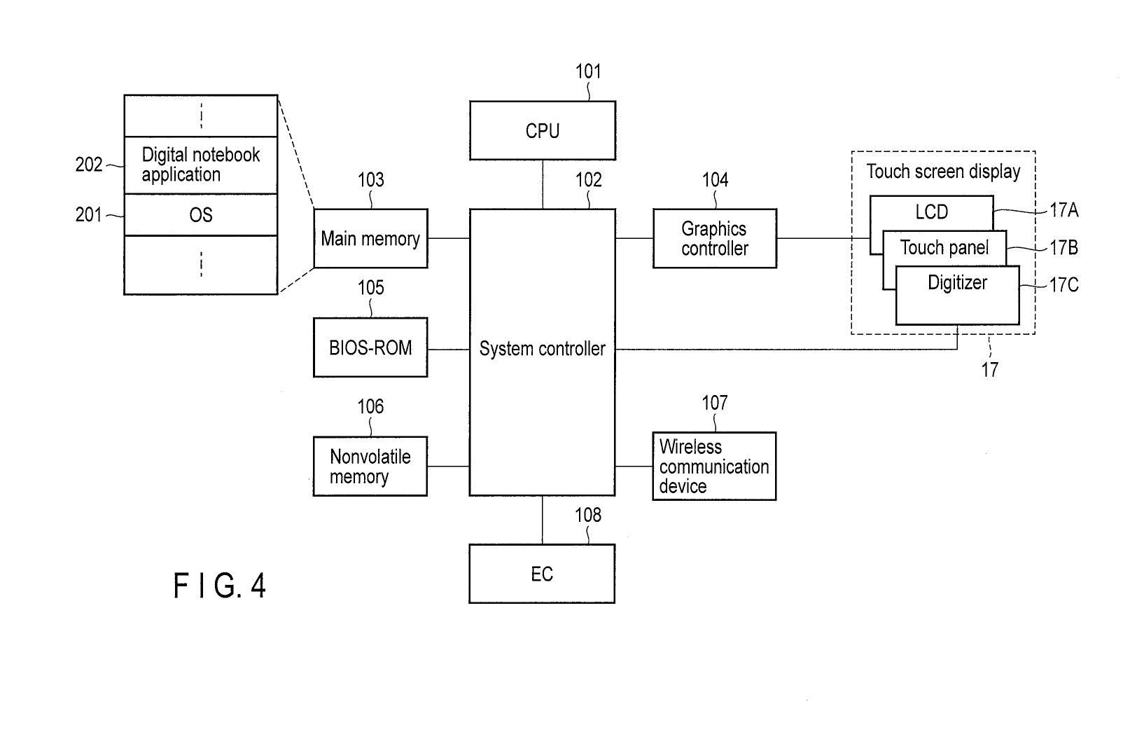

FIG. 4 is a diagram showing the system configuration of the tablet computer 10.

The tablet computer 10 includes, as shown in FIG. 4, a CPU 101, a system controller 102, a main memory 103, a graphics controller 104, a BIOS-ROM 105, a nonvolatile memory 106, a wireless communication device 107, and an embedded controller (EC) 108.

The CPU 101 is a processor that controls operations of various components in the tablet computer 10. The CPU 101 executes various kinds of software loaded from the nonvolatile memory 106 as a storage device into the main memory 103. Such software includes an operating system (OS) 201 and various application programs. The application programs include a digital notebook application program 202. The digital notebook application program 202 has a function of creating and displaying the above handwritten document and a function of setting one or more layers in the handwritten document.

Also, the CPU 101 executes a basic input/output system (BIOS) stored in the BIOS-ROM 105. The BIOS is a program for hardware-control.

The system controller 102 is a device connecting a local bus of the CPU 101 and various components. The system controller 102 also includes a memory controller that controls access to the main memory 103. The system controller 102 also has a function to perform communication with the graphics controller 104 via a serial bus of the PCI EXPRESS standard or the like.

The graphics controller 104 is a display controller that controls an LCD 17A used as a display monitor of the tablet computer 10. A display signal generated by the graphics controller 104 is sent to the LCD 17A. The LCD 17A displays a screen image based on the display signal. On the LCD 17A, a touch panel 17B and a digitizer 17C are arranged. The touch panel 17B is a capacitance-type pointing device for inputting on the screen of the LCD 17A. The touch position on the screen where a finger is touched and movement of the touch position are detected by the touch panel 17B. The digitizer 17C is an electromagnetic induction-type pointing device for inputting on the screen of the LCD 17A. The contact position on the screen where the pen 100 is contacted and movement of the contact position are detected by the digitizer 17C.

The wireless communication device 107 is a device configured to perform wireless communication such as wireless LAN, 3G mobile communication or the like. The EC 108 is a one-chip microcomputer including an embedded controller for power management. The EC 108 has a function to turn on or turn off the tablet computer 10 in response to an operation of the power button by the user.

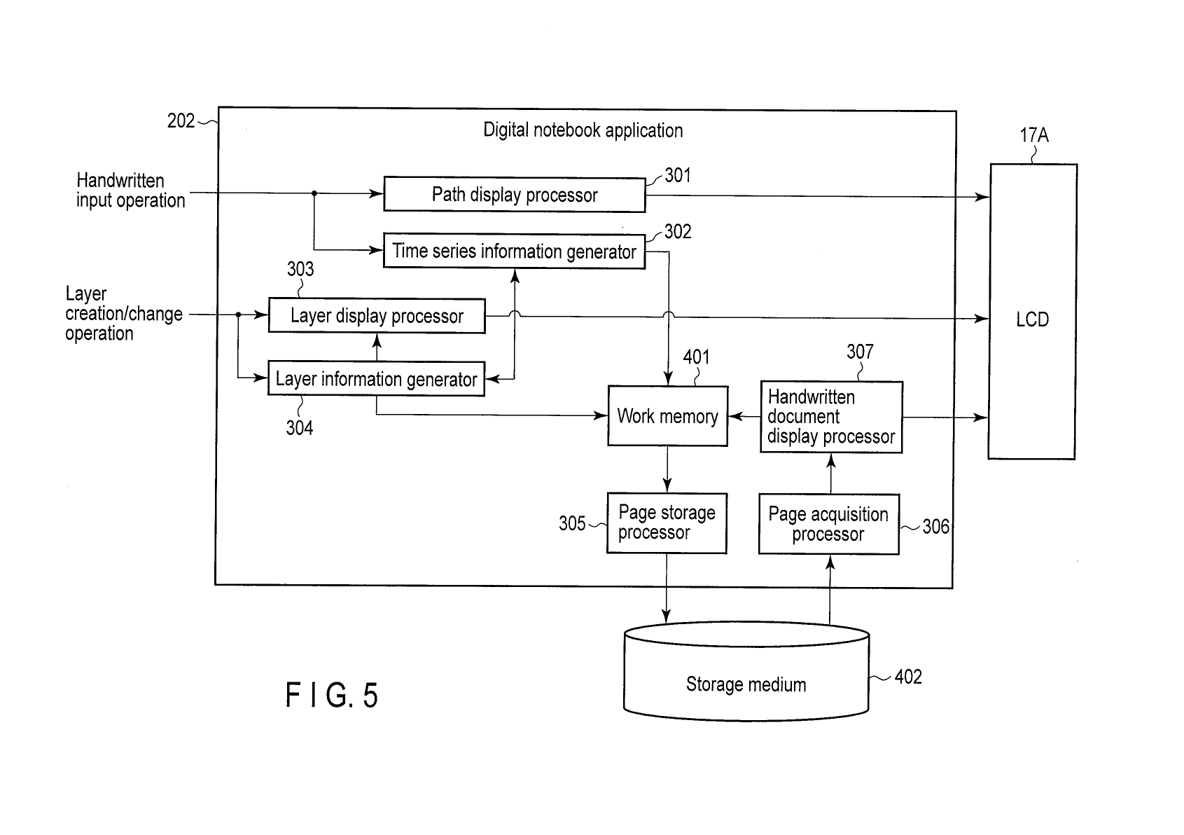

Next, the functional configuration of the digital notebook application program 202 will be described with reference to FIG. 5. As described above, the digital notebook application program 202 creates, displays, or edits a handwritten document by using stroke data input by a handwritten input operation on the touch-screen display 17. A handwritten document processed by the digital notebook application program 202 includes one or more layers. For example, a base document layer (first layer) to be a base of a handwritten document is included in the handwritten document and a layer can further be created in response to a layer creation operation by the user on the touch-screen display 17. The user can write a handwritten stroke (a character, figure or the like) to each of one or more layers by a handwritten input operation on the touch-screen display 17. That is, the digital notebook application program 202 performs processing to create, display, or edit a handwritten document including a plurality of strokes written to each of one or more layers.

The touch-screen display 17 is configured to detect an occurrence of events such as “touch”, “move (slide)”, and “release”. “Touch” is an event indicating that an external object has come into contact with the screen. “Move (slide)” is an event indicating that the contact position has moved while an external object is in contact with the screen. “Release” is an event indicating that an external object has been released from the screen.

The digital notebook application program 202 includes, for example, a path display processor 301, a time-series information generator 302, a layer display processor 303, a layer information generator 304, a page storage processor 305, a page acquisition processor 306, and a handwritten document display processor 307.

First, processing when a layer is created in a handwritten document will be described below.

The layer display processor 303 and the layer information generator 304 perform processing to create a layer in a target handwritten document (handwritten page) to be processed. That is, the layer display processor 303 and the layer information generator 304 perform processing to create a layer in a handwritten document in response to a layer creation operation on the touch-screen display 17 performed by the user.

When a new handwritten document is created, the layer display processor 303 and the layer information generator 304 create a base document layer (first layer) to be a base of the handwritten document. That is, when a new handwritten document is created, the layer information generator 304 generates layer information indicative of the base document layer and the layer display processor 303 displays an image indicative of the base document layer in the handwritten document on the screen. The base document layer is, for example, a layer covering the entire handwritten document. That is, the base document layer has the same size as the handwritten document. The base document layer is arranged in the bottom layer (deepest plane) of one or more layers in a handwritten document. Thus, the base document layer may be handled not as a layer, but as a handwritten document (handwritten page) itself.

When a handwritten document including the base document layer is displayed on the screen of the touch panel display 17, the layer display processor 303 and the layer information generator 304 create a new layer (second layer) on the base document layer based on a region specified by a layer creation operation. The second layer has, for example, the same size as the handwritten document at the maximum and is arranged in any position inside the handwritten document. The second layer may be a transparent layer through which a stroke handwritten in the lower layer is visible or an opaque layer through which a stroke handwritten in the lower layer is invisible.

The user can perform a layer creation operation to specify any region inside a handwritten document being displayed by using a “layer creation” tool to create a layer in any region inside the handwritten document. In response to the region inside the handwritten document specified by the layer creation operation, the layer information generator 304 determines the region where a new layer is created and generates layer information indicative of the new layer. The layer display processor 303 displays an image (for example, a sticky note image) showing the new layer inside the handwritten document. When a transparent layer is created, the layer display processor 303 may display an image (for example, a tab image) showing the presence of a layer, instead of an image showing a layer itself.

The layer information generator 304 may temporarily store generated layer information in a work memory 401.

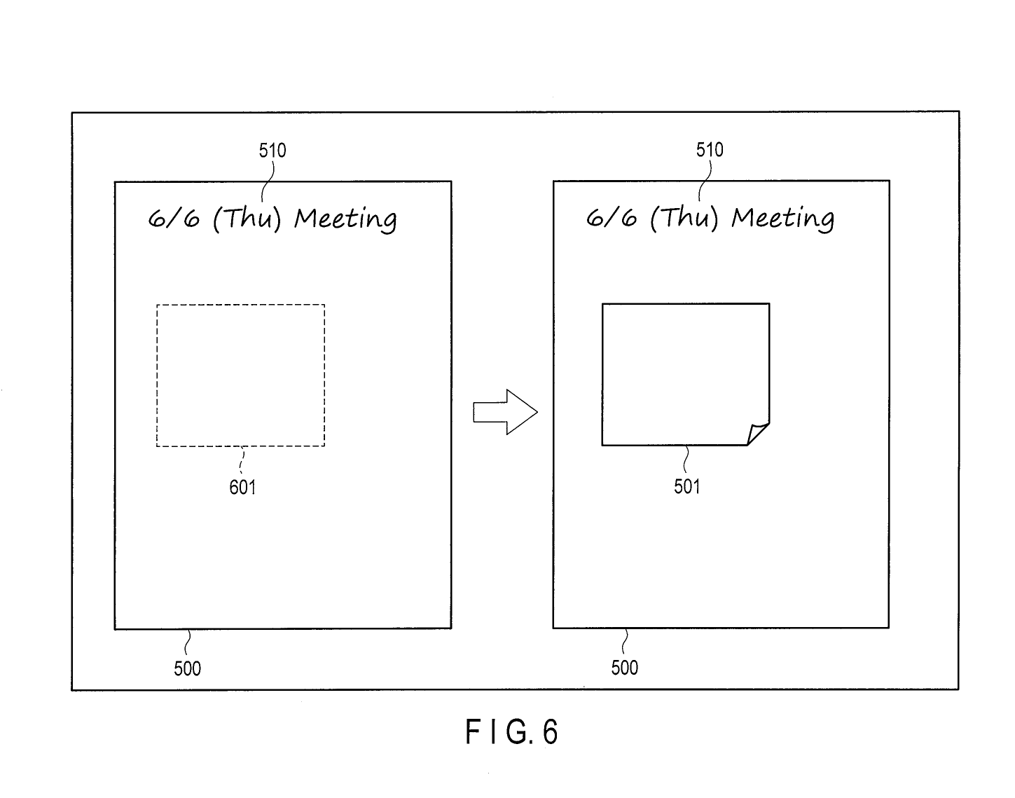

FIG. 6 shows an example of the creation of a layer in a handwritten document by using a handwritten document screen 500 displayed on the touch-screen display 17. It is assumed that the handwritten document is already provided with a base document layer 510 to be a base of the handwritten document. The base document layer 510 corresponds to, for example, a page itself of a paper notebook.

The user uses, for example, the “layer creation” tool to specify an arbitrary region 601 in the handwritten document screen 500 by an operation to move the pen 100 or a finger on the handwritten document screen 500. In response to the arbitrary region 601 being specified by the user, a layer (sticky note layer) 501 corresponding to the specified region 601 is created in the handwritten document. The sticky note layer 501 is laid on the base document layer 510. The sticky note layer 501 has an opaque background color like a paper sticky note and thus, the region corresponding to the sticky note layer 501 in the base document layer 510 is hidden by the sticky note layer 501. Thus, the user can handwrite on the sticky note layer 501 and a region in the base document layer 510 excluding the region corresponding to the sticky note layer 501.

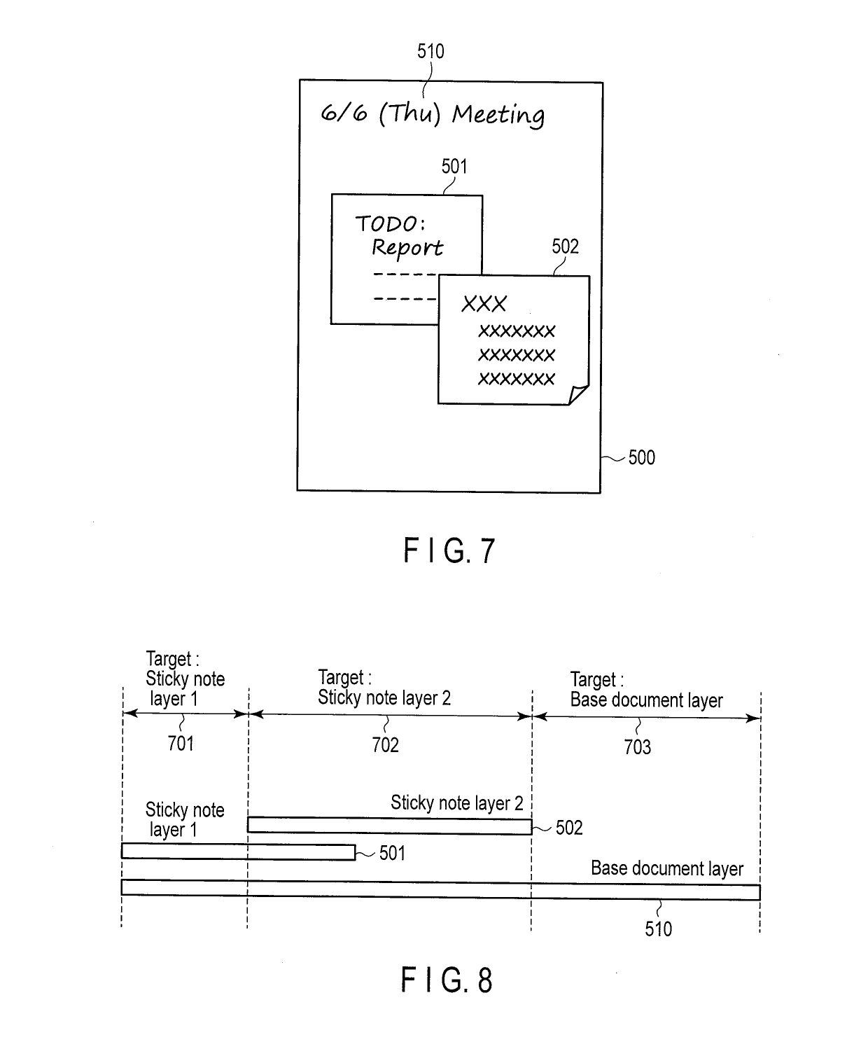

Also, as shown in FIG. 7, a plurality of sticky note layers 501, 502 can be created in the handwritten document by using the handwritten document screen 500. The user can separately write two pieces of description having different attributes related to description written to the base document layer 510 to the first sticky note layer 501 and the second sticky note layer 502. That is, the user can classify information in a handwritten document by attribute by creating layers. It is also possible to create a plurality of layers for each of a plurality of users to handwrite to a handwritten document or to create separate layers for one user to handwrite at different times.

An example of the layers 501, 502, 510 will be described with reference to FIG. 8. In the example shown in FIG. 8, the first sticky note layer 501 is superimposed on the base document layer 510 and further, the second sticky note layer 502 is superimposed on the first sticky note layer 501. In other words, a portion of the first sticky note layer 501 is overlapped with the second sticky note layer 502 and a portion of the base document layer 510 is overlapped with the first sticky note layer 501 and the second sticky note layer 502.

The user can perform a handwriting input to the top layer (front plane) of the layers on the handwritten document screen 500. Therefore, the user can perform a handwriting input to the first sticky note layer 501 in a first region 701, to the second sticky note layer 502 in a second region 702, and to the base document layer 510 in a third region 703.

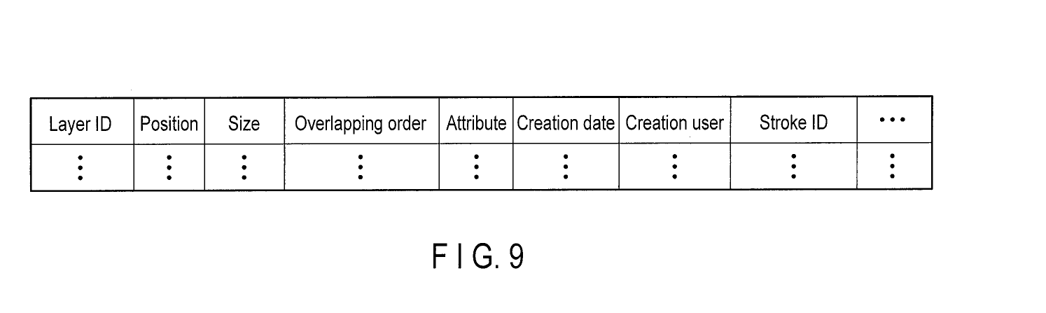

Next, a configuration example of layer information will be described with reference to FIG. 9. The layer information is generated or updated by the layer information generator 304 when a layer in a handwritten document is created or edited.

Layer information includes one or more entries corresponding to one or more layers set to a handwritten document. Each entry includes, for example, the layer ID, position, size, overlapping order, attributes, creation date/time, creation user, and stroke ID. In an entry corresponding to a layer, “layer ID” indicates identification information given to the layer. “Position” (for example, X and Y coordinates) indicates the position where the layer is arranged on the handwritten document. “Size” indicates the size of the layer. If, for example, the layer is a rectangle, “size” indicates the width and height of the rectangle. “Overlapping order” indicates the overlapping position of the layer among one or more layers. For example, a value allocated according to the overlapping order of one or more layers is set to “overlapping order”. “Attributes” indicate attributes indicative of description written to the layer. “Creation date/time” indicates the creation date/time when the layer is created. “Creation user” indicates the user who has created the layer. For example, the name of the user or identification information given to the user is set to “creation user”. “Stroke ID” indicates the stroke ID of the stroke (stroke IDs of strokes) corresponding to a handwritten path written to the layer.

Instead of “position” and “size”, layer information may include, for example, a coordinates indicative of the shape of the layer. A layer having any shape can be defined by the coordinates.

Next, processing when a stroke (such as a character, mark, figure, or table) is handwritten to a handwritten document including one or more layers will be described.

The path display processor 301 and the time-series information generator 302 detect a handwritten input operation by receiving an event of “touch” or “move (slide)” generated by the touch-screen display 17. The “touch” event includes coordinates of the contact position. The “move (slide)” event includes coordinates of the destination contact position. Therefore, the path display processor 301 and the time-series information generator 302 can receive a series of coordinates corresponding to a path of movement of the contact position from the touch-screen display 17. The path display processor 301 and the time-series information generator 302 starts detection of a handwritten input operation in accordance with a determination to create or edit a layer or the end of using the “layer creation” tool or “layer change” tool.

The path display processor 301 receives a series of coordinates from the touch-screen display 17 and displays, based on the coordinates, the path of each handwritten stroke by a handwritten input operation using the pen 100 or the like on the screen of the LCD 17A. The path of the pen 100 while the pen 100 is in contact with the screen, that is, the path of each stroke is drawn on the screen of the LCD 17A by the path display processor 301. For example, the path display processor 301 displays a first stroke handwritten in a first region corresponding to a first layer (for example, the base document layer 510) in the first region and displays a second stroke handwritten in a second region corresponding to a second layer (for example, the first sticky note layer 501) in the second region.

The time-series information generator 302 receives the above coordinates output from the touch-screen display 17 and generates, based on the coordinates, time-series information having a structure as described in detail with reference to FIG. 3. In this case, the time-series information, that is, coordinates and time stamp information corresponding to each point of a stroke may temporarily be stored in the work memory 401.

The time-series information generator 302 and the layer information generator 304 associate time-series information and layer information. If, for example, the first stroke is handwritten in the first region corresponding to the first layer (for example, the base document layer 510), the time-series information generator 302 and the layer information generator 304 store a pair of first layer information and first stroke data (time-series information) in a storage medium 402. The first layer information is indicative of the first region. The first stroke data (time-series information) corresponds to the first stroke. If the second stroke is handwritten in the second region corresponding to the second layer (for example, the first sticky note layer 501), the time-series information generator 302 and the layer information generator 304 store a pair of second layer information and second stroke data in the storage medium 402. The second layer information is indicative of the second region. The second stroke data corresponds to the second stroke.

More specifically, the time-series information generator 302 outputs the generated time-series information to the layer information generator 304. Then, the layer information generator 304 detects to which of one or more layers each stroke indicated by the received time-series information is written by using layer information (layer information temporarily stored in the work memory 401) indicative of one or more layers in the handwritten document. Then, the layer information generator 304 adds the stroke ID of the stroke written to the layer to the entry of layer information corresponding to the detected layer. Accordingly, strokes written to the handwritten document can be processed layer by layer by using the time-series information and layer information. For the association of time-series information and layer information, a method of adding the layer ID indicative of the layer to which each stroke is written to the time-series information may be adopted. The time-series information generator 302 and the layer information generator 304 may temporarily store the associated time-series information and layer information in the work memory 401.

A case in which a plurality of strokes is handwritten by a handwritten input operation performed on the touch-screen display 17 in a handwritten document in which, as shown in FIG. 6, the sticky note layer (second layer) 501 is created on the base document layer (first layer) 510 is assumed. If the strokes are handwritten in the first layer, the layer information generator 304 associates first layer information corresponding to the first layer with time-series information including stroke data items corresponding to the strokes, and then stores the associated first layer information and time-series information. If the strokes are handwritten in the second layer, the layer information generator 304 associates second layer information corresponding to the second layer with time-series information including stroke data items corresponding to the strokes, and then stores the associated second layer information and time-series information.

Further, the layer display processor 303 and the layer information generator 304 can perform processing to move any layer in a handwritten document, change the size, change the overlapping order, or delete the layer. That is, the layer display processor 303 and the layer information generator 304 perform processing to change a layer included in a handwritten document in response to a layer change operation performed on the touch-screen display 17 by the user.

By using the “layer change” tool, the user can select any layer from one or more layers in a handwritten document and perform a layer change operation instructing to move the selected layer, change the size thereof, change the overlapping order, or delete the layer. The layer display processor 303 and the layer information generator 304 perform processing instructed by the layer change operation on the layer selected by the operation. Since the base document layer 510 serves as a base of handwritten document, the layer 510 may be always arranged as the bottom layer of one or more layers in the handwritten document. Additionally, the layer 510 may be set such that the position or size of the base document layer 510 cannot be changed and the base document layer 510 cannot be deleted.

If, for example, a region corresponding to a layer is instructed to move to a first position by a layer change operation, the layer display processor 303 displays strokes in the region in a region corresponding to the layer moved to the first position. Then, the layer information generator 304 updates layer information of the layer based on the first position and updates the corresponding stroke data based on the positions of the strokes after the region corresponding to the layer being moved to the first position.

More specifically, if the movement of a layer to the first position is instructed by a layer change operation, the layer information generator 304 determines the region of the layer moved to the first position and updates the corresponding layer information, and the layer display processor 303 displays an image indicative of the layer moved to the first position. If any handwritten stroke is included in the moved layer, the layer information generator 304 updates time-series information corresponding to the stroke in accordance with the position in the layer moved to the first position, and the layer display processor 303 displays the stroke in the corresponding position in the layer moved to the first position. Incidentally, an operation history indicating that time series coordinates of each moved stroke have been changed may be added to the time-series information.

If the change of size of a layer is instructed by a layer change operation, the layer information generator 304 updates layer information corresponding to the layer in accordance with the changed size, and the layer display processor 303 displays an image indicative of the layer in the changed size.

If the change of overlapping order of a layer is instructed by a layer change operation, the layer information generator 304 updates layer information corresponding to the layer in accordance with the changed overlapping order, and the layer display processor 303 displays an image indicative of the layer in the changed overlapping order. The layer display processor 303 similarly displays handwritten strokes included in the layer in accordance with the changed overlapping order.

If the deletion of a layer is instructed by a layer change operation, the layer information generator 304 deletes layer information corresponding to the layer. The layer display processor 303 then deletes the image indicative of the layer from the screen of the display 17. If any stroke is included in the layer to be deleted, the layer information generator 304 deletes time-series information (stroke data item) corresponding to the stroke and the layer display processor 303 deletes the path representing the stroke from the screen of the display 17. Each deleted stroke data item does not necessarily have to be deleted from time series coordinates in time-series information and an operation history indicative of the deletion of each stroke data item may be added to the time-series information.

Further, the layer display processor 303 and the layer information generator 304 can perform processing to merge (integrate) two layers in the handwritten document. By using the “layer change” tool, the user can select two layers from one or more layers in a handwritten document and perform a layer change operation instructing to merge the two layers.

It is assumed that, for example, the merge of the base document layer 510 and the sticky note layer 501 is instructed by a layer change operation. In this case, the layer information generator 304 adds the stroke IDs of strokes in the sticky note layer 501 to the entry of layer information corresponding to the base document layer 510. The layer display processor 303 deletes an image indicative of the sticky note layer 501 from the screen of the display 17 and displays the strokes in the sticky note layer 501 in the base document layer 510. Then, the layer information generator 304 deletes the entry of layer information corresponding to the sticky note layer 501.

The page storage processor 305 stores the generated time-series information and layer information in the storage medium 402 as handwritten document (handwritten page) data. The storage medium 402 is, for example, a storage device in the tablet computer 10 or a storage device of a server.

The page acquisition processor 306 reads any handwritten document data stored in the storage medium 402. The read handwritten document data is sent to the handwritten document display processor 307. The handwritten document display processor 307 analyzes time-series information and layer information included in the handwritten document data and then displays, based on the analysis result, a handwritten document (handwritten page) in which one or more layers are laid and the path of each stroke indicated by the time-series information is drawn on the layers, on the screen.

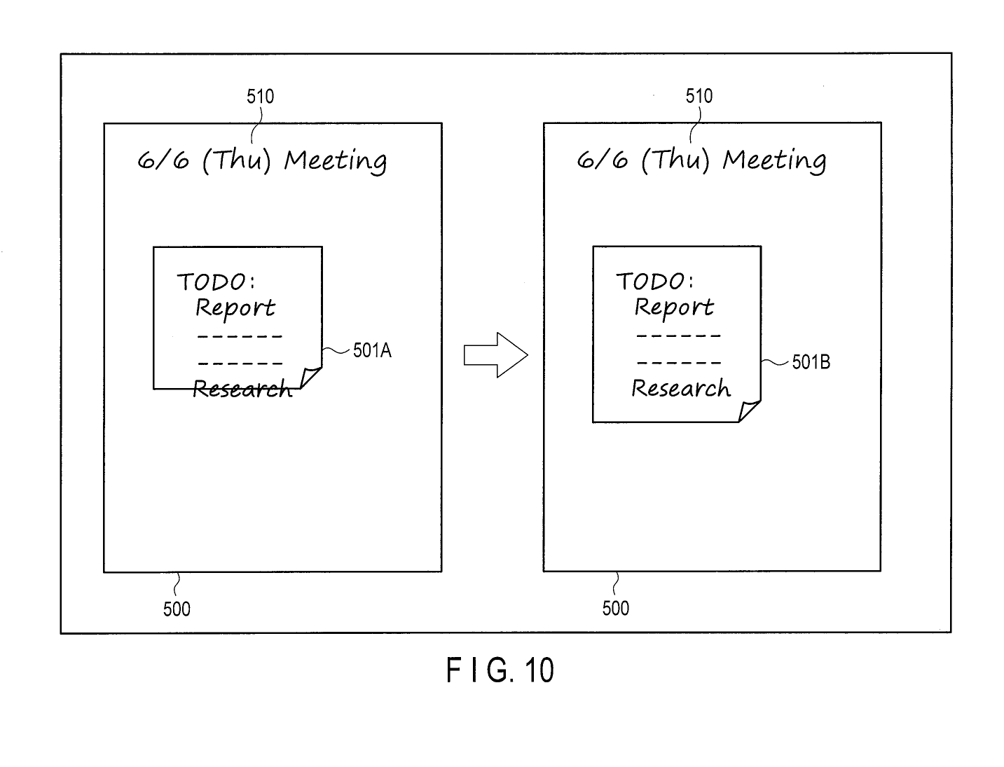

FIG. 10 shows an example in which the region of a layer is changed in accordance with handwritten input by the user. It is assumed here that when the user performs handwritten input into a sticky note layer 501A displayed on the handwritten document screen 500, a portion of a handwritten stroke (handwritten character, figure or the like) is written outside the region of the sticky note layer 501A.

In the example shown in FIG. 10, a portion of the handwritten character string “Research” is written outside the region of the sticky note layer 501A. In this case, the region of the sticky note layer 501A is widened by the layer display processor 303 and the layer information generator 304 so that the handwritten character string “Research” is included in the region. That is, the sticky note layer 501A is changed to a sticky note layer 501B so that the handwritten character string “Research” is included in the region.

More specifically, if, for example, a handwritten path (that is, a continuous coordinate series corresponding to the path) is a path that moves out of the layer region, it is assumed that it becomes impossible to include a handwritten character, figure or the like within the layer (a handwritten character, figure or the like running off the layer) during handwritten input. If, for example, the path of a stroke input by handwriting links from a coordinate in the sticky note layer (second layer) 501A to a coordinate in the base document layer (first layer) 510, the layer display processor 303 and the layer information generator 304 change the region of the sticky note layer 501A to a region further including the stroke. That is, the sticky note layer 501A is automatically widened (extended) so that the path of the handwritten stroke is included. Accordingly, the region of a layer can extended in accordance with a handwritten path without an explicit operation to change the size of the layer being performed by the user. Additionally, a handwritten character, figure or the like intended by the user to be written within a layer can be processed appropriately so as to be displayed within the layer. Whether the path of a handwritten stroke moves out of a layer may be determined based on not only a coordinate data series corresponding to the stroke, but also time-series information corresponding to a plurality of strokes handwritten before or after the stroke.

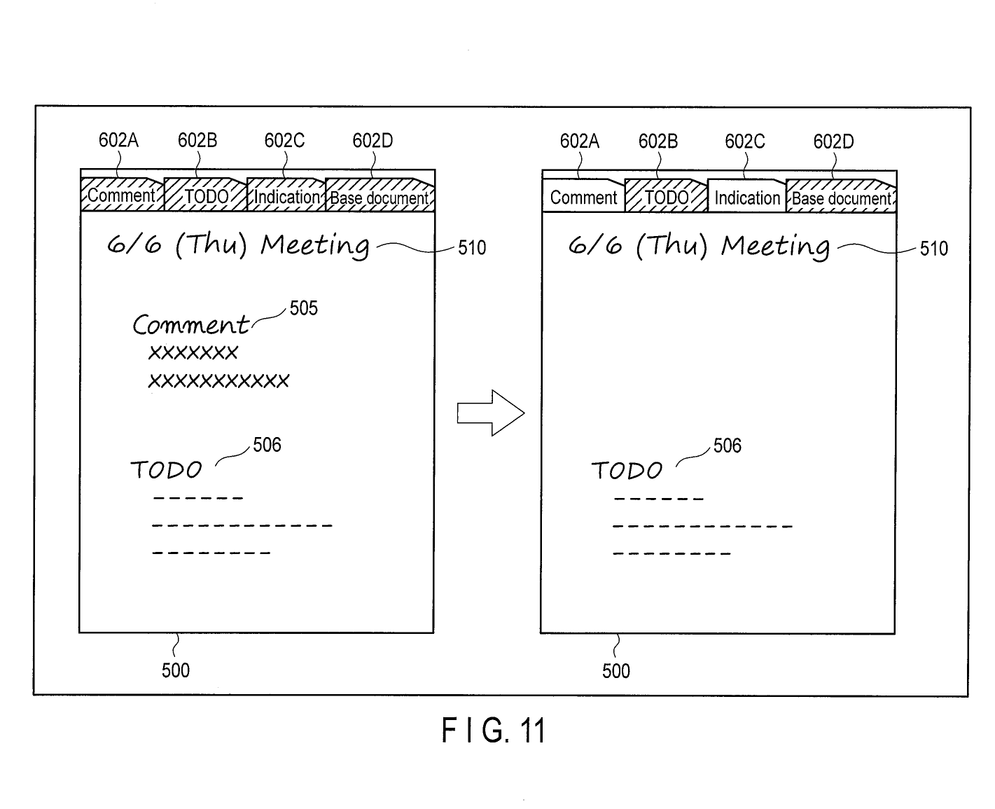

Next, FIG. 11 shows an example provided with a transparent layer for a handwritten document. In the handwritten document screen 500 shown in FIG. 11, three transparent layers, a “comment” layer 505, a “TODO” layer 506 and an “indication” layer, are laid on the base document layer 510. These three layers are, for example, layers covering the entire handwritten document. Incidentally, a handwritten stroke is not yet written to the “indication” layer.

Tags 602A, 602B, 602C, 602D corresponding to each of four layers in the handwritten document are displayed on the handwritten document screen 500 so that the user can recognize that the handwritten document includes the transparent layers. The user can also make a selection of whether to display the corresponding layer on the screen by using the tags 602A, 602B, 6020, 602D.

In the handwritten document screen 500, a transition from a state in which all layers are displayed on the screen to a state in which only the base document layer 510 and the “TODO” layer 506 are displayed on the screen occurs in response to an operation to select the “TODO” tag 602B and the “base document” tag 602D when all the tags 602A, 602B, 602C, 602D are selected. Accordingly, the user can selectively display layers in a handwritten document.

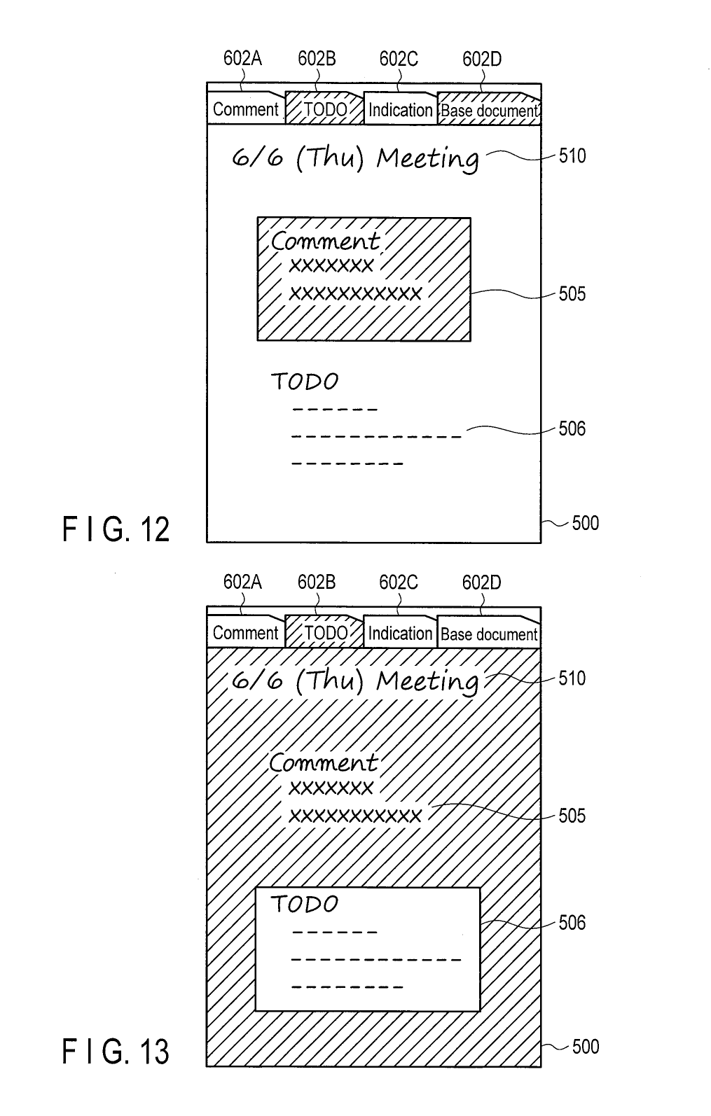

Also, as shown in FIGS. 12 and 13, the display form of layer may be changed in accordance with the selected state of the tags 602A, 602B, 602C, 602D. In the example shown in FIGS. 12 and 13, it is assumed that the user brings the “TODO” tag 602B to a selected state.

In the handwritten document screen 500 shown in FIG. 12, the base document layer 510 and the “TODO” layer 506 are displayed in a first display form and the “comment” layer 505 is displayed in a second display form. In the handwritten document screen 500, the user can recognize that the layer (the “TODO” layer 506) corresponding to the tag in the selected state is an active layer by, for example, displaying layers in the first display form deeply and layers in the second display form lightly. The user can perform a handwritten input operation on an active layer.

Incidentally, as shown in FIG. 12, the base document layer 510 may be displayed always in the first display form regardless of the selection of the tag 602D by the user. The display form of layer in the handwritten document screen 500 only needs to allow the user to distinguish an active layer corresponding to the selected state of the tag like displaying layers in the first display form brightly and layers in the second display form darkly and displaying layers in the first display form and layers in the second display form in different colors.

As shown in FIG. 13, the display form of the base document layer 510 may be changed in accordance with the selection of the tag 602D by the user. In the handwritten document screen 500, the “TODD” layer 506 is displayed in the first display form (for example, deeply) and other layers including the base document layer 510 are displayed in the second display form (for example, lightly).

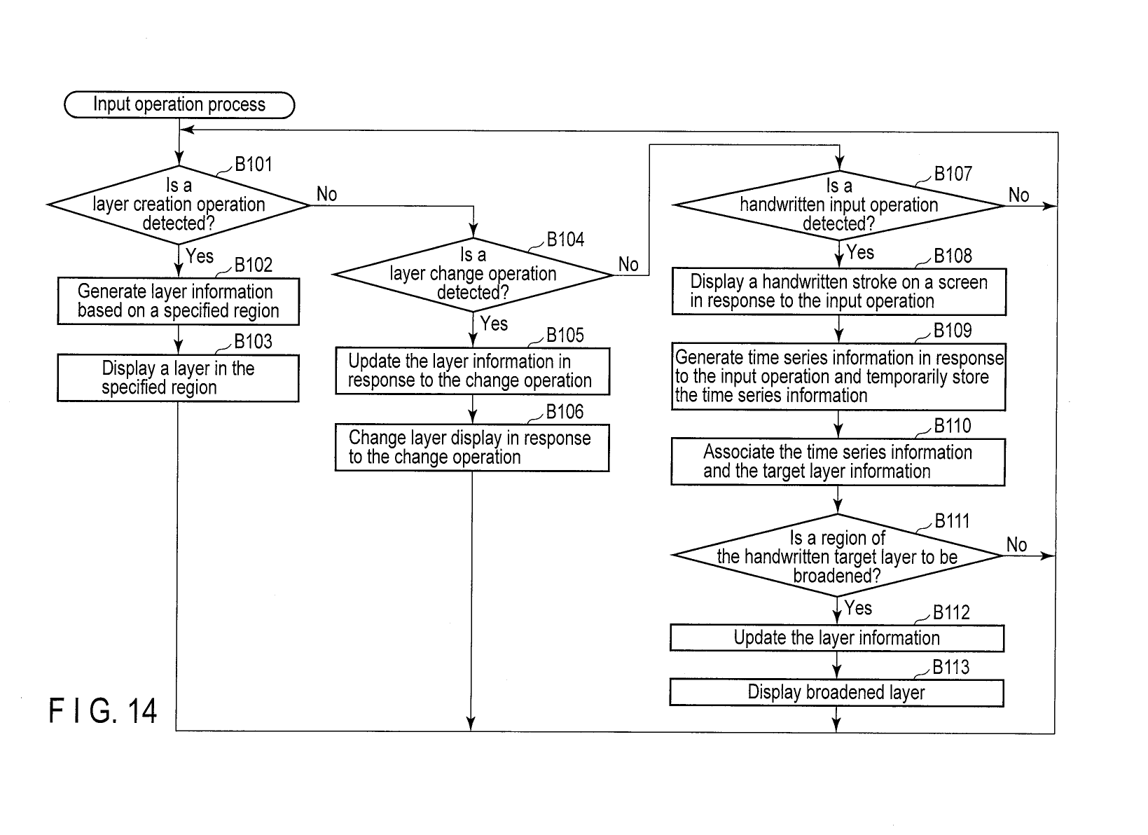

Next, the procedure of an input operation process executed by the digital notebook application program 202 will be described with reference to the flowchart in FIG. 14.

First, the layer display processor 303 and the layer information generator 304 determine whether any layer creation operation performed by the user on the touch-screen display 17 is detected (block B101). The layer creation operation is an operation to specify any region in a handwritten document by using the “layer creation” tool. If a layer creation operation is detected (YES in block B101), the layer information generator 304 generates layer information having a configuration as described in detail with reference to FIG. 9 based on the region specified by the layer creation operation (block B102). Then, the layer display processor 303 displays an image indicative of a layer in the region specified by the layer creation operation (block B103).

If no layer creation operation is detected (NO in block B101), the layer display processor 303 and the layer information generator 304 determine whether any layer change operation is detected (block B104). The layer change operation is an operation instructing to move (change the position of) any created layer in the handwritten document, change the size thereof, change the overlapping order, change the display/hiding of the layer, or delete the layer by using, for example, the “layer change” tool. If a layer change operation is detected (YES in block B104), the layer information generator 304 updates layer information in response to the layer change operation (block B105). Then, the layer display processor 303 changes the display of the layer in response to the layer change operation (block B106).

If no layer change operation is detected (NO in block B104), the path display processor 301 and the time-series information generator 302 determine whether any handwritten input operation is detected (block B107). If a handwritten input operation is detected (YES in block B107), the path display processor 301 displays a handwritten path (for example, the path of movement of the pen 100) on the screen (display 17) in response to the handwritten input operation (block B108). Then, the time-series information generator 302 generates the above time-series information based on the coordinate series corresponding to the handwritten path and temporarily stores the time-series information in the work memory 401 (block B109). Further, the layer information generator 304 determines the layer (handwriting target layer) intended for the handwritten input operation based on the coordinate series corresponding to the handwritten path, the region corresponding to each of one or more layers set in the handwritten document, and the overlapping order of layers. The layer information generator 304 then associates layer information corresponding to the determined handwriting target layer with the generated time-series information (block B110). The layer information generator 304 associates the layer information with the time-series information by adding the stroke IDs in the generated time-series information to the layer information corresponding to the handwriting target layer.

Next, the layer information generator 304 determines whether to broaden the region corresponding to the handwriting target layer (block B111). If, for example, a portion of the handwritten path is written outside the region of the handwriting target layer, the layer information generator 304 determines that it is necessary to broaden the region corresponding to the handwriting target layer. If the region corresponding to the handwriting target layer should be broadened (YES in block B111), the layer information generator 304 determines the region of the layer broadened so that the handwritten path is included and updates the layer information in accordance with the determined region (block B112). Then, the layer display processor 303 displays an image corresponding to the broadened layer on the screen (block B113).

If the region corresponding to the handwriting target layer should not be broadened (that is, if the handwritten path is included in the region corresponding to the current handwriting target layer) (NO in block B111), the process returns to block B101.

If no handwritten input operation is detected (NO in block B107), the process returns to block B101.

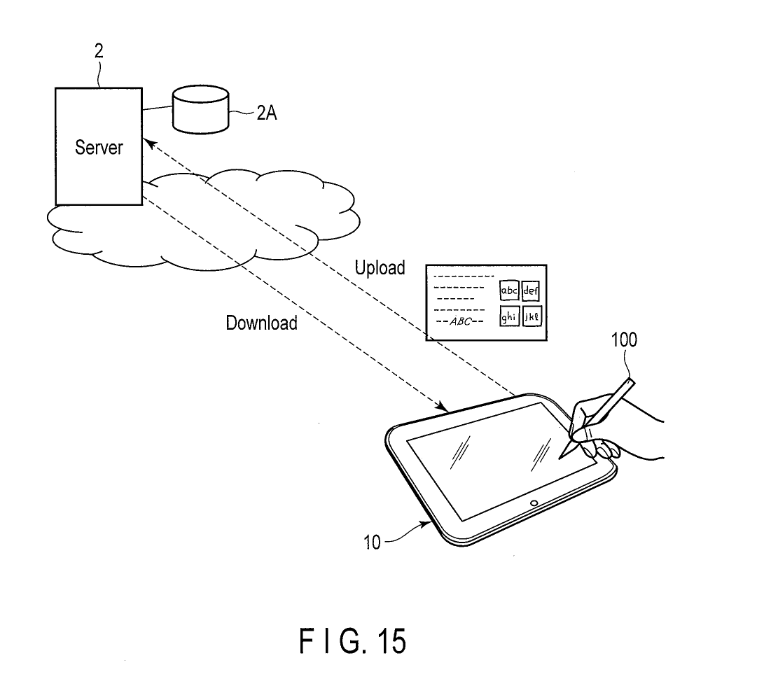

Next, FIG. 15 shows an example of an operation of the tablet computer 10 and an external device. The tablet computer 10 can be linked to a cloud system. That is, the tablet computer 10 includes a wireless communication device such as a wireless LAN and can perform communication with a server 2 on the Internet. The server 2 may be a server that executes an online storage service or other various cloud computing services.

The server 2 includes a storage device 2A such as a hard disk drive (HDD). The tablet computer 10 can transmit handwritten document data to the server 2 over a network to store the data in the HDD 2A of the server 2. To ensure secure communication between the tablet computer 10 and the server 2, the server 2 may authenticate the tablet computer 10 when communication is started. In this case, a dialog to prompt the user to input the ID or password may be displayed on the screen of the tablet computer 10 or the ID of the tablet computer 10 or the ID of the pen 100 may automatically be transmitted from the tablet computer 10 to the server 2.

Accordingly, even if the capacity of storage in the tablet computer 10 is small, the tablet computer 10 can handle a large number of handwritten documents or a large-capacity handwritten document.

Further, the tablet computer 10 can read (download) any handwritten document data stored in the HDD 2A of the server 2 and display one or more layers to which the path of each stroke indicated by the read handwritten document data drawn on the screen of the display 17 of the tablet computer 10.

Thus, according to the embodiment, the storage medium in which handwritten document data is stored may be a storage device in the tablet computer 10 or the storage device 2A of the server 2.

When the handwritten document screen 500 is displayed on the touch-screen display 17 of the tablet computer 10, the tablet computer 10 may transmit operation information indicative of various operations (such as a handwritten input operation, layer creation operation, and layer change operation) on a handwritten document using the touch-screen display 17 to the server 2. Since a program having a configuration corresponding to the above digital notebook application program 202 is executed on the server 2, a handwritten document process corresponding to the operation information transmitted from the tablet computer 10 is performed. The server 2 transmits, for example, an image (image data) of the handwritten document to which the process corresponding to the operation information has been subjected to the tablet computer 10. Then, the tablet computer 10 displays the image of the handwritten document transmitted from the server 2 on the handwritten document screen 500 of the touch-screen display 17.

Accordingly, an input process using the touch-screen display 17 and a display process of a handwritten document are executed by the tablet computer 10 and a process to create (update) and store handwritten document data is executed by the server 2, thereby the load of process of the tablet computer 10 can be reduced.

The server 2 may also create a layer for each user accessing a handwritten document or a layer in a handwritten document accessed for each date/time so that handwritten strokes are drawn in the created layer. The server 2 may draw handwritten strokes by a user in a layer for the user in a handwritten document by analyzing the strokes.

According to the present embodiment, as described above, a handwritten document having a plurality of layers can easily be handled. The layer display processor 303 and the layer information generator 304 perform processing to create a layer in a target handwritten document (handwritten page) and also to change the created layer in response to detection of a layer creation/change operation by the user using the touch-screen display 17. The path display processor 301 and the time-series information generator 302 display paths of strokes handwritten by a handwritten input operation in a handwritten document including one or more layers on the screen in response to detection of the handwritten input operation by the user using the touch-screen display 17 and generate time-series information corresponding to the strokes. The generated time-series information is stored with layer information indicative of the region corresponding to the layer to which the corresponding stroke is handwritten. Accordingly, handwritten strokes can be handled in units of layers and thus, a layer and strokes handwritten to the layer can together be handled in accordance with an operation on the layer.

All the process procedures on a handwritten document according to this embodiment can be realized by a computer program. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a layer creator configured to create, when a handwritten document comprising a first layer is displayed on a screen, a second layer;
a storage processor configured to store first layer information and first stroke data in storage if a first stroke is handwritten in a first region corresponding to the first layer, and to store second layer information and second stroke data in the storage if a second stroke is handwritten in a second region corresponding to the second layer, the first layer information indicative of the first region, the first stroke data corresponding to the first stroke, the second layer information indicative of the second region, and the second stroke data corresponding to the second stroke; and
a display processor configured to display the first stroke in the first region and to display the second stroke in the second region.

2. The electronic apparatus of claim 1, wherein the display processor is configured to display the first stroke in a first form and to display the second stroke in a second form.

3. The electronic apparatus of claim 1, wherein the layer creator is configured to change the second region to a region further comprising an input stroke if the input stroke links a coordinate in the second region to a coordinate in the first region.

4. The electronic apparatus of claim 1, wherein the display processor is configured to display the second stroke in a third region corresponding to the second layer moved to a first position if movement of the second region corresponding to the second layer to the first position is instructed by a layer change operation and
the storage processor is configured to update the second layer information based on the first position and to update the second stroke data based on a position of the second stroke in the third region.

5. The electronic apparatus of claim 1, wherein the display processor is configured to delete the second stroke handwritten in the second layer from the screen if deletion of the second layer is instructed by a layer change operation and
the storage processor is configured to delete the second layer information and stroke data corresponding to the second stroke in the time-series information from the storage.

6. The electronic apparatus of claim 1, further comprising a touch-screen display,
wherein the layer creation operation and an input operation of the first stroke and the second stroke are input by using the touch-screen display.

7. A handwritten document processing method comprising:
creating, when a handwritten document comprising a first layer is displayed on a screen, a second layer;
storing first layer information and first stroke data in storage if a first stroke is handwritten in a first region corresponding to the first layer, the first layer information indicative of the first region and the first stroke data corresponding to the first stroke;
storing second layer information and second stroke data in the storage if a second stroke is handwritten in a second region corresponding to the second layer, the second layer information indicative of the second region and the second stroke data corresponding to the second stroke; and
displaying the first stroke in the first region and displaying the second stroke in the second region.

8. A computer-readable, non-transitory storage medium having stored thereon a program which is executable by a computer, the program controlling the computer to execute functions of:
creating, when a handwritten document comprising a first layer is displayed on a screen, a second layer based on a region specified by a layer creation operation;
storing first layer information and first stroke data in storage if a first stroke is handwritten in a first region corresponding to the first layer, the first layer information indicative of the first region and the first stroke data corresponding to the first stroke;
storing second layer information and second stroke data in storage if a second stroke is handwritten in a second region corresponding to the second layer, the second layer information indicative of the second region and the second stroke data corresponding to the second stroke; and
displaying the first stroke in the first region and displaying the second stroke in the second region.
